(19) United States
(12) Patent Application Publication
(10) Pub. No.: US 2013/0330702 A1
(43) Pub. Date: Dec. 12, 2013

(54) SYSTEM AND METHOD FOR BOOKING TIME OF ANOTHER FOR A COMMUNICATION SESSION

(71) Applicant: Mark Bowring, Dallas, TX (US)

(72) Inventor: Mark Bowring, Dallas, TX (US)

(73) Assignee: Mediaday Incorprated, Dallas, TX (US)

(21) Appl. No.: 14/001,455

(22) PCT Filed: Feb. 24, 2012
(86) PCT No.: PCT/US12/26633

§ 371 Date: Aug. 23, 2013

Related U.S. Application Data
(60) Provisional application No. 61/446,426, filed on Feb. 24, 2011.

(51) Int. Cl. G09B 5/06

(52) U.S. Cl. CPC G09B 5/06
USPC 434/308; 434/322

(57) ABSTRACT

According to an embodiment of the disclosure, a system for a remote instructional session comprises one or more servers (240). The one or more servers receive, from an endpoint (220) corresponding to an instructor, information associated with a schedule for which users may book time for an instructional session with the instructor (440). The one or more servers also receive, from an endpoint (210) corresponding to a user, search parameters for instructors (340) and then provide, to the endpoint corresponding to the user, search results corresponding to the search parameters for the instructors. The one or more servers additionally receive, from the endpoint corresponding to the user, booking information for a particular time with the instructor (350) and then initiate a remote instructional session over a instructional session over a network at the particular time (370, 460).

### TECHNICAL FIELD

The present disclosure is directed, in general, to communication systems, and more specifically, to a system and method for booking time of another for a communication session.

### BACKGROUND

Personal one-on-one instructional sessions can provide a tremendous set of advantages to a student. Among other advantages, a student may be allowed to move at his or her own pace (which may be slower or faster than an average person) and to learn in a manner most conducive to the student's learning style. Notwithstanding such advantages, a variety of difficulties can arise in such one-on-one instructional sessions. From a student and/or their parent's perspective, it can be difficult to find the “right” instructor. For example, most parents and students do not know where to search for an instructor, let alone, obtain information on the credentials of the instructor. Further, assuming an instructor is found, it can be time consuming to contact the references of an instructor to ascertain others' experiences with the instructor. Additionally, sometimes the best instructors are geographically located at a distance that prohibitively makes the one-on-one session impractical.

From an instructor's standpoint, the lack of flexibility in scheduling and the difficulty in obtaining clients during particular desired time periods can frustrate one's desire to be an instructor in the first place. Further difficulties include travel that may be required for the instructional session and/or the awkwardness that may develop when an instructor enters the home of a student—especially if the instructor is also a teacher of the student.

### SUMMARY

According to an embodiment of the disclosure, a system for a remote instructional session comprises one or more servers. The one or more servers receive, from an endpoint corresponding to an instructor, information associated with a schedule for which users may book time for an instructional session with the instructor. The one or more servers also receive, from an endpoint corresponding to a user, search parameters for instructors and then provide, to the endpoint corresponding to the user, search results corresponding to the search parameters for the instructors. The one or more servers additionally receive, from the endpoint corresponding to the user, booking information for a particular time with the instructor and then initiate a remote instructional session over a network at the particular time. The remote instructional session includes a sharing of digital information between the endpoints associated with the user and the instructor.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “server” means any device, system or part thereof that controls at least one operation, such a device may be implemented in hardware, firmware or software, or some combination of at least two of the same. It should be noted that the functionality associated with any particular server may be centralized or distributed, whether locally or remotely.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified block diagram illustrative of a communication system that may be utilized by various embodiments of the disclosure;

FIG. 2 illustrates components that may use the communication system described in FIG. 1 to establish a virtual instructional session;

FIG. 3 illustrates an example process for a user interacting with the system, according to an embodiment of the disclosure;

FIG. 4 illustrates an example process for an instructor interacting with the system, according to an embodiment of the disclosure;

FIG. 5 illustrates an example process that may be associated with mediation, according to an embodiment of the disclosure;

FIG. 6 illustrate several non-limiting examples of tools that may be provided to a instructor utilizing the system;

FIG. 7 illustrates several non-limiting examples of tools that may be provided to users of the system;

FIG. 8 illustrates an example interface of a profile of an instructor, according to an embodiment of the disclosure;

FIG. 9 shows a process for submitting questions to the “cloud”, according to an embodiment of the disclosure;

FIG. 10 illustrates a scheduling time of a “high profile” individual, according to an embodiment of the disclosure; and

FIG. 11 is an embodiment of a general purpose computer that may be used in connection with other embodiments of the disclosure to carry out any of the above-referenced functions and/or serve as a computing device for endpoint(s) of FIG. 1.

### DETAILED DESCRIPTION

The FIGURES, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

Given the difficulties described in the BACKGROUND, certain embodiments of the disclosure provide a system that addresses some or all of the difficulties. In certain embodiments, instructors and students come together with one another in a virtual instructional session. Building on the adage that “time is one's most valuable asset,” such a virtual instructional system may, among other things, provide time efficiency for both the student and the instructor by eliminating travel. Such a virtual instructional system may also mitigate against the awkwardness of person-to-person encounters in a home or other location.

According to other embodiments, a user submits a question to the “cloud” and waits as answerers race to provide the correct answer.

In yet other embodiments, a user obtains access to the time of a “high profile” individuals and attempts to book some of his or her time.

In yet another embodiments, a user or users may obtain credit towards a college degree for interacting with an instructor in a virtual apprenticeship and/or mentorship.

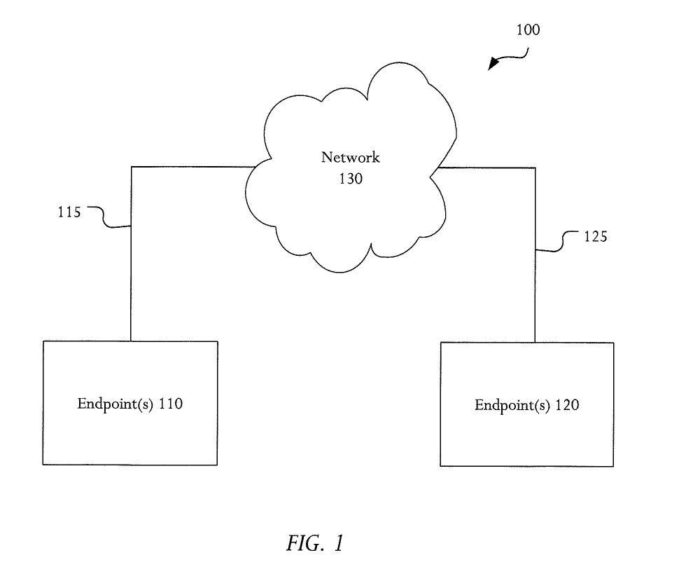

FIG. 1 is a simplified block diagram illustrative of a communication system 100 that may be utilized by various embodiments of the disclosure. The communication system 100 can be utilized to facilitate communication between endpoint(s) 110 and endpoint(s) 120 through a communication network 130. As used herein, “endpoint” may generally refer to any object, device, software, or any combination of the preceding that is generally operable to communicate with another endpoint. The endpoint(s) may represent a user, which in turn may refer to a user profile representing a person. The user profile may comprise, for example, an address for the user, a user name, a passcode, other user information, or any combination of the preceding. Additionally, the endpoint(s) may represent a device that comprises any hardware, software, firmware, or combination thereof operable to communicate through the communication network 130.

Examples of an endpoint(s) include, but are not necessarily limited to, a computer or computers (including servers, applications servers, enterprise servers, desktop computers, laptops, netbooks, tablet computers (e.g., IPAD)), cameras, telephones, mobile phones (e.g., including IPHONE and ANDROID-based phones), components in a cloud-computing network, or any other device or component of such device(s) suitable for communicating information to and from the communication network 130. Endpoints may support Internet Protocol (IP) or other suitable communication protocols. Endpoints may additionally include a medium access control (MAC) and a physical layer (PHY) interface that conforms to IEEE 801.11. If the endpoint is a device, the device may have a device identifier such as a MAC address and may have a device profile that describes the device.

The communication network 130 and links 115, 125 to the communication network 130 may include, but are not limited to, a public or private data network; a local area network (LAN); a metropolitan area network (MAN); a wide area network (WAN); a wireline or wireless network (GSM, CDMA, LTE, WIMAX, or the like); a local, regional, or global communication network; portions of a cloud-computing network; a communication bus for components in a system; an optical network; a satellite network; an enterprise intranet; other suitable communication links; or any combination of the preceding. In particular embodiments, portions of the links 115, 125 or communication network 130 may be on the Internet. In other embodiments, portions may not be on the Internet.

Although endpoint generally appears as being in a single location, the endpoint(s) may be geographically dispersed, for example, in cloud computing scenarios. As used in this document, “each” may refer to each member of a set or each member of a subset of a set.

When the endpoints(s) 110, 130 communicate with one another, any of a variety of security schemes may be utilized. As an example, in particular embodiments, endpoint(s) 120 may represent a client and endpoint(s) 130 may represent a server in client-server architecture. The server and/or servers may host a website. And, the website may have a registration process whereby the user establishes a username and password to authenticate or log in to the website. The website may additionally utilize a web application for any particular application or feature that may need to be served up to the website for use by the user.

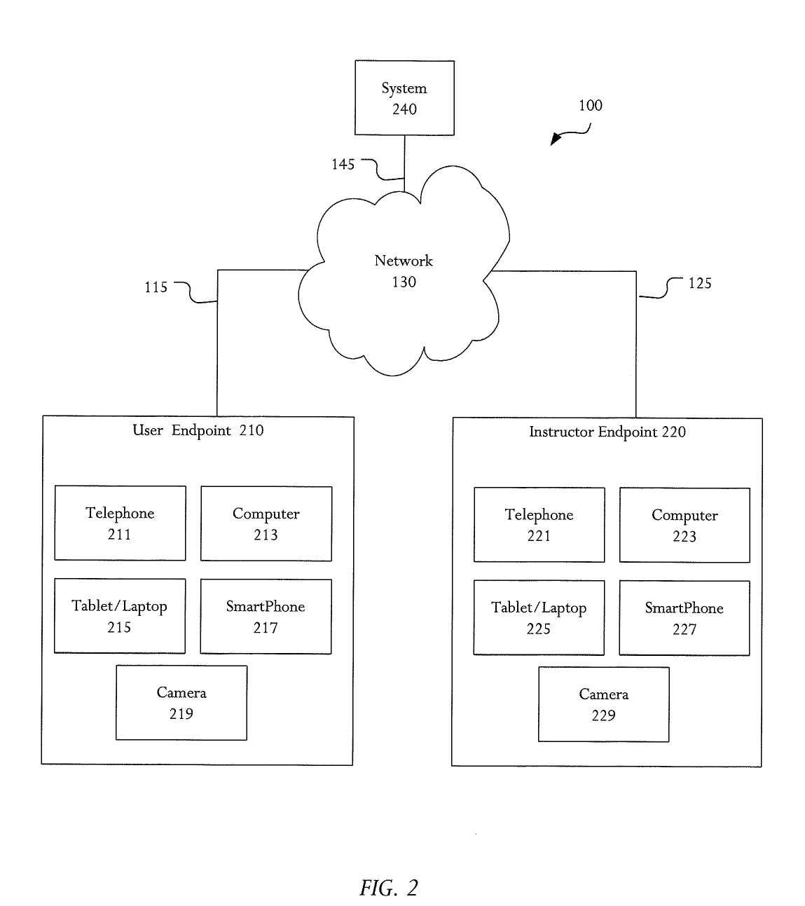

FIG. 2 illustrates components that may use the communication system 100 described in FIG. 1 to establish a virtual instructional session. In FIG. 2, the endpoints 110, 120 may correspond to a student or user endpoint 210, a teacher or instructor endpoint 220, and a system 240. In particular configurations, the “student” may be a minor and certain described uses of the system herein by a “user” are by the student's parents. Accordingly, with reference to the instructional system described herein, a “user” may refer to the student, the parent, or both.

To communicate with one another in instructional sessions described below, the instructor and user may utilize any of the technology described in FIG. 1 and/or any other technology that will allow the user and instructor to communicate with one another. Example communication technologies provided in FIG. 2 include telephones 211/221, computers 213/223, tablets or laptops 215/225, smartphones 217/227, and cameras 219/229. These technologies are non-limiting. Other may be utilized in other embodiments. And, in particular configurations, a combination of technologies may be utilized, for example, a phone and a computer. Furthermore, in particular embodiments, the type of instruction being received may determine the types of technologies used in the communication.

The system 240, which may be part of the network 130, is shown separately in FIG. 2 (connected by link 145) to show that the user endpoint 210 and instructor endpoint 220 may utilize resources of the system 240 for communication. For example, in particular configurations, a website (described in further details below) may be stored on portions of the system 240. Additionally, in other configurations, the system 240 may be used in the streaming of media between the user endpoint 210 and the instructor endpoint 220. The system 240, itself, may comprise a variety of servers, including web servers, application servers, and database servers.

A variety of commercial off-the-shelf technologies allow one to communicate with one another. Such communication technologies include Skype, WebEx, and Gotomymeeting. A variety of others exist, including technologies that allow one to write on a virtual blackboard and let another remotely connected endpoint see what is being written. Any of these technologies may be utilized in or by the system 240, user endpoint 210, and/or instructor endpoint 220.

As indicated above, in particular embodiments, the system 240 may host a website. Although the term “website” is used, it should be understood that any other type of technology may be utilized to provide information to the user endpoints 210 and/or instructor endpoints 220. For example, in particular configurations, information may be served up to the endpoint 110 and endpoint 120 using communication mediums that do not technically fall with the purview of traditional “websites.” That is, the information is accessible through a communication channel other than the “web.”

While certain uses of the system 240 may be described in the context of a traditional educational tutor setting, it should be understood that the instructional sessions are not so limited. The instructor, according to various embodiments of the disclosure, may include test preparation instructors for preparing one for virtually any test, including the SAT, PSAT, ACT, GMAT, LSAT, ISEE tests, HSPT, EIT/FE, PE, CPA examinations, FINRA examinations, and any other test.

Additionally, in particular embodiments, the instructor may be an athletic instructor who is advising—in real time—an athlete on, for example, on their swing or a workout sessions. As just one example, in particular embodiments, the instructor may be a virtual trainer who is instructing an individual through their particular workout. In such embodiment, the device associated with the user may be a mobile device. Additionally, in particular embodiments, the device may communicate, for example, a measured heart rate or other biological information and/or location information to the instructor. For example, a user may wear a device capable of detecting its location (using GPS, assisted GPS, or other location determination techniques) and communicating such information to an instructor. Thus, the instructor may determine a speed and/or heart rate of the user and instruct the user on a further workout.

In yet other embodiments, the instructor may be a self-help instructor for someone who needs instructions in a do-it-yourself project such as, laying tiles on a kitchen floor, knitting, changing a belt in an engine of a car, or installing a liquid-cooling system in a computer. In such embodiments, the user may show the instructor with an appropriate camera what is being done and the instructor may provide feedback. The types of instructors in such self-help assistance are virtually limitless.

In yet other embodiments, an instructor may diagnose a problem associated with the user. Such a diagnosis may be based on images fed to the instructor via a camera as well as other items that may be provided to the instructor, including answers to questions the instructor may have. The problems may be problems with appliances at the house, problems with a car, medical problems, and any other type of problems.

In yet further embodiments, an instructor may be a virtual real-world experience mentor that talks about encountered experiences. In such embodiments, which are discussed further below, a user may be able to obtain college course credit for spending time with such real-world mentors.

In yet further embodiments, one may have a virtual musical lesson using an instrument that is specially connected to the network, for example, to allow detection of missed or hit notes. As a simple example, a networked microphone may be placed near a regular instrument to detect which notes are hit. In certain embodiments, software may be programmed on a device already having such technology (e.g., IPAD) to enable such functionality. The detected notes may then be compared against sheet music for accuracy and communicated to the instructor along with the audio stream of what is being played. In such scenarios, the instructor may thus see (and hear) which notes are missed or hit and provide instruction back to the user.

Although the above examples have been provided, it should be understood that other types of instructional sessions may avail from the teaching of the disclosure provided herein.

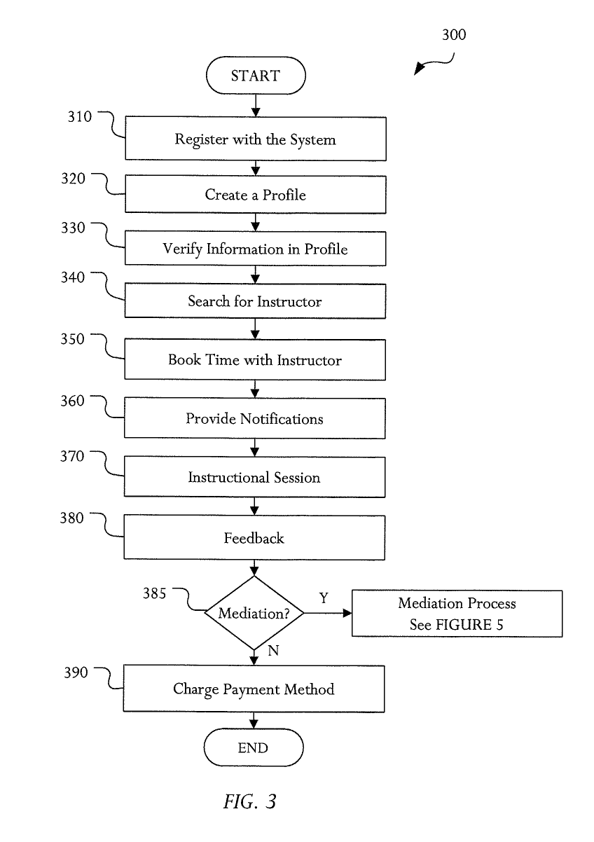

FIG. 3 illustrates an example process 300 for a user interacting with the system 240, according to an embodiment of the disclosure. Although a particular order has been shown in FIG. 3, the process 300 need not necessarily follow the shown order. Additionally, although particular steps are described, in certain configurations, some, none, or all of the steps may occur.

As referenced above, the user may be associated with the user endpoint 210 of FIG. 2. At step 310, a user may register with the system 240. The amount of information in the registration, itself, may depend on the configuration. For example, in particular configurations, a user may simply supply an email address, a phone number, or a name. Additionally, in the registration process, a user may create a username and password to later log-in or authenticate with the system 240.

At step 320, the user may create a profile with information. In particular configurations, this may be done at the time of registration. The profile may include, but is not limited to, name, address, telephone number, email address, school, courses, textbooks, payment methods and other information. In particular configurations, the system 240 may include a template of information to gather—some of which may be optional. In other configurations, a user may be allowed to provide other information not identified by the template.

With regards to such profile information, in particular configurations, a user may specify what type of information may be shared and with whom it may be shared. For example, a user may wish to share certain information with other users and certain information only with instructors. Although a profile is described as being created in this configuration, in other configurations, a profile may not be created at all.

At one of the profile creation or registration at steps 310 or 320, a user may also specify communication capabilities they have for the instructional session, for example, corresponding to the devices described in FIG. 1 or FIG. 2. If a user is unsure whether or not their user endpoint 210 has the capability for a particular type of communication, the system 240 may use a variety of techniques to check to see if particular methods of communication work. As non-limiting example, code may be sent to the user endpoint 210 to analyze the device or environment in which the user is operating to determine whether or not particular methods of communication will work.

In particular configurations, a user with a single username/password may use different devices at different times to communicate. For example, the user may use video chat features of an IPHONE or ANDROID phone at certain times and a desktop computer or laptop at other times.

At step 330, a verification process may occur for any information that a user entered. For example, if a person entered an email address, the system 240 may send an email to the entered email address with a special link. The special link—when clicked upon—may verify the user has access to the email address. As another example, when a user enters a phone number, the system may call the phone number and simultaneously provide numbers the user must enter upon answering the phone. Other verifications include, but are not limited to, payment verifications method used for credit cards or checking accounts (e.g., trial depositions for checking accounts and temporary charges for credit cards).

At step 340, the student may search for an instructor. In particular configurations, recommendations may be made for a particular user based on entered profile information and/or historical information gathered from other users. As a non-limiting example, the system may calculate that users with similar profiles have found certain instructors useful (e.g., as determined by feedback described below). Any of a variety of search methodologies and technologies may be utilized according to various configurations. Non-limiting examples follow.

In certain configurations, a user may simply enter search keywords into a search box and the system 240 will return relevant search results for those keywords. For example, if a book title is entered along with a city, the system 240 may return all instructors in a city that have taught from the particular book title.

In other configurations, a user may browse according to any suitable hierarchy of information for the particular type of instructor. Non-limiting hierarchical examples for educational instructors include instructors by city, instructors by school, instructors by subject, instructors by textbook, and instructors by courses taught. Other types of hierchial examples may be used for other types of instructors.

In other configurations, a user may be allowed to enter specified parameters to narrow down possible results. The parameters may include filters and/or factors. A filter may only provide results corresponding to the filtered item. As an example filter, a user may indicate that they only want instructors that have at least a certain rating. As another example filter, a user may indicate that they only want instructors that have taught from the very textbook the user is currently using. As an example factor, a user may indicate that a high rating is one factor and whether or not a instructors has taught from a textbook is another factor. In providing factors for the search, a user may additionally provide a “weight” for each factor. Then, the results will provide the best fit for the factors and provided weights. In particular configurations, factors and filters may both be used simultaneously.

The search for an instructor is not limited to the particular examples provided herein. After reviewing this specification, one of ordinary skill in the art will recognize that other search methodologies and technologies may be utilized to narrow down possible instructor candidates.

In particular configurations, step 340 need not occur after steps 310, 320, and 330 and may occur before any of steps 310, 320, or 330. For example, in particular configurations a user (without registering) may be allowed to view instructor results or hits, but not the details of an instructor. In other embodiments, a user (without registering) may be allowed to view the details of the instructor, but may not be allowed to book time of the instructor.

In yet other configurations, a user may not be required to register at all and may simply book an instructional session upon providing valid payment information.

At step 350, a user may book time and/or times for a particular instructor. For example, after reviewing a particular instructor's profile and available schedule, an instructional session and/or sessions may be scheduled. In particular configurations, a set of sessions may be booked together. In particular embodiments, an online interface may be provided that allows a user to simply select the available time slot or slots. In booking the time slot or slots, in particular configurations, a user may be prompted for a payment method. In other configurations, a user may have already provided payment information (e.g., in registration or profiling) and may only be required to confirm the session.

In particular configurations, certain types of instructors may all have the same rate for a particular period of time. In other configurations, like instructors may have like rates (e.g., elementary school instructors may have an elementary school rate whereas college instructors may have a college rate). In certain configurations, instructors that have instructed in a certain number of sessions and have achieved a certain rating may command a higher rate as allowed by the system 240. In yet other configurations, an instructor may be able to set a rate within prescribed limits of the system 240.

As part of the booking, a user may upload the particular items that they want to work on. For example, a user may upload a certain problem. Additionally, in particular configurations, a user may define what items they want to discuss in the instructional session. In certain configurations, the system 240 may provide prompts that inquire of the user what they want to discuss.

At step 360, after booking, the instructor and user may be notified that the session has been booked. In particular configurations, additional appropriate reminders may be sent, for example, by text, email, or phone. Additionally, where multiple sessions have been booked as a package, a reminder may be sent for each session.

At step 370, the actual instructional session may occur. In particular configurations both the user and the instructor may be logged into the system 240 using appropriate communication tools such as Webex, Skype, or any other suitable communication tool. In other configurations, one or both may be given simultaneous phone calls by the system to initiate at least the voice part of the communication. Any other communication techniques may be utilized as described above. The session may last for different times, depending on configuration.

At step 380, after the instructional session has been completed, a user may be allowed to provide comments or feedback on the session—either directly following the session or within a number of days after the session. If a user provides feedback, in particular configurations that feedback will not post to the system 240 for review by others until after review by a moderator for, among other thing, inappropriate language.

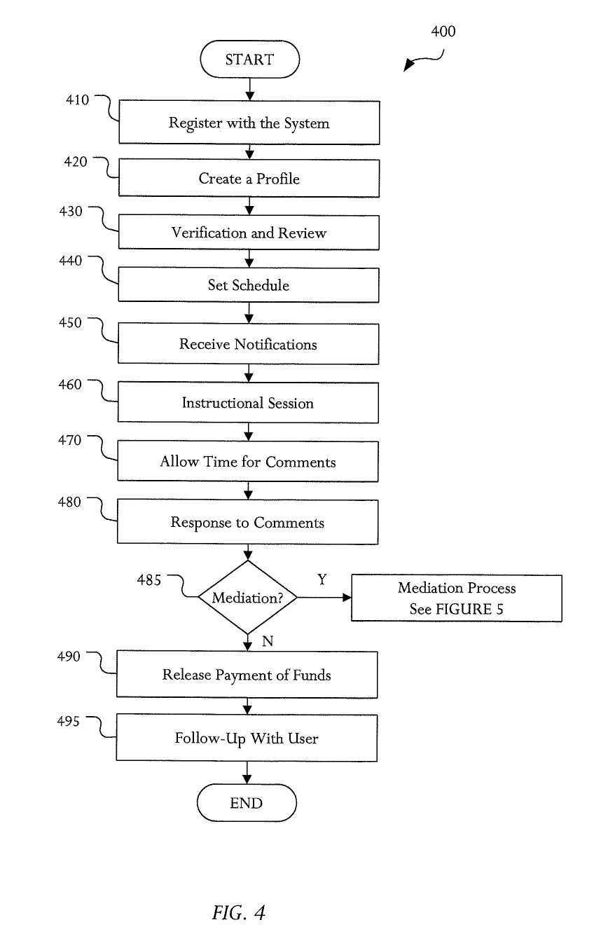

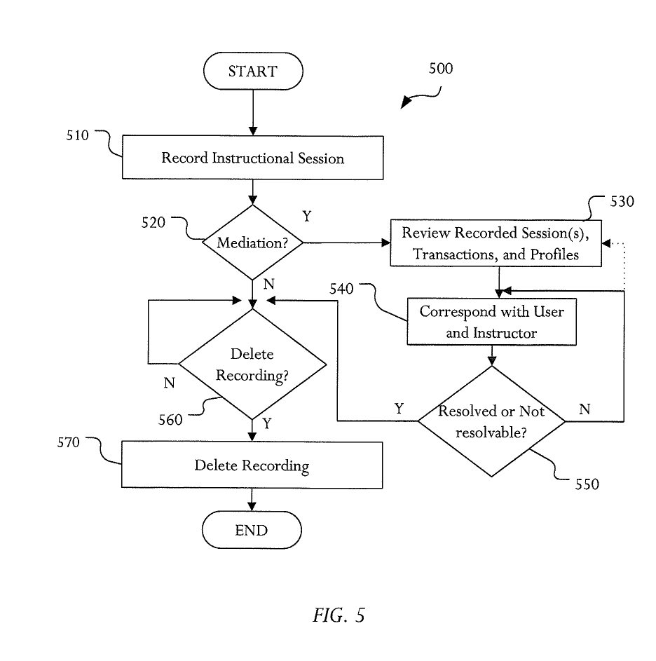

At step 385, a determination may be made as to whether mediation is necessary. In particular configurations, the feedback provided at step 380 may indicate that mediation needs to occur. In other configurations, a user may specifically request mediation. If mediation needs to occur, portions of the process 500 described in FIG. 5 may occur. If not, the process 300 proceeds to step 390.

At step 390, a user's payment method is charged for the session. In particular configurations, this may occur automatically after a given number of days after the session (and provided no mediation occurs). In particular configurations, a portion or percentage of an amount charged to the user may be deposited into an account specified by the instructor.

FIG. 4 illustrates an example process 400 for an instructor interacting with the system 240, according to an embodiment of the disclosure. Similar to FIG. 3, although a particular order has been shown in FIG. 4, the process 400 need not necessarily follow the shown order. Additionally, although particular steps are described, in certain configurations, some, none, or all of the steps may occur.

At step 410, an instructor may register with the system 240. Similar to a user's registration, the amount of information in the registration, itself, may depend on the configuration. For example, in particular configurations, an instructor may simply supply an email address, a phone number, or a name. Additionally, in the registration process, the instructor may create a username and password to later log-in or authenticate with the system 240.

At step 420, the instructor may create their profile. The profile information may include, but is not limited to, name, email, the methods of communication utilized, subjects for instruction (for educational instructors), textbooks utilized (for educational instructors), and methods which they desire payment (e.g., direct deposit or physical check). In particular configurations, the information supplied by the instructor may be utilized for matching with users seeking an instructor. Accordingly, in particular configurations, if an instructor offers too little information, the system 240 may remind the instructor that users will utilize the profile information to find an instructor. In particular configurations, the profile of the instructor will change based on the users that enter into instruction sessions with the particular instructor and, for example, rate or comment on the instructor.

At step 430, a verification and review process occurs. As part of this process, a criminal background check may occur. Additionally, profiled information may be verified for accuracy. For example, if an instructor indicates that they are a teacher at a particular school, an administrator (person or software) may verify electronically or otherwise that the instructor actually teaches at the school. Additionally, the system 240 may verify any other information, including the information described above with reference to step 330 of FIG. 3.

At step 440, the instructor may provide his or her available schedule to the system 240 for posting and search by users. In particular configurations, an instructor's schedule may not be posted until after the verification and review process of step 430 has been completed. After posting, the schedule will change when a user has booked time.

At step 450, when a user books an instructor's time, the instructor will receive notifications in the same manner described with reference to step 360 in FIG. 3.

At step 460, the actual instructional session may occur in the same manner described with reference to step 370 of FIG. 3.

At step 470, for a particular instructional session, the instructor waits for comments or feedback for the instructional session from a user—if any.

At step 480, if a comment is provided, it is sent to the instructor and the instructor is given the opportunity to provide a response. An instructor need not provide a response. In particular configurations, the actual posting of the comments and responses to comments do not occur until a moderator reviews both for, among other thing, inappropriate language.

At step 485, a determination may be made as to whether mediation is necessary. In particular configurations, the response to comments provided at step 480 may indicate that mediation needs to occur. In other configurations, an instructor may specifically request mediation. If mediation needs to occur, portions of the process 500 described in FIG. 5 may proceed. If not, the process 400 proceeds to step 490.

At step 490, payment of funds may be released to the instructor in the manner prescribed in the instructor's profile. As indicated above, in particular configurations, the instructor may receive a percentage of the charges made to the user. As also referenced above, in particular configurations, instructors may all have the same rate for a particular period of time. In other configurations, like instructors may have like rates (e.g., elementary school instructors may have an elementary school rate whereas college instructors may have a college rate). In certain configurations, instructors that have instructed a certain number of sessions and have achieved a certain rating may command a higher rate as allowed by the system 240. In yet other configurations, an instructor may be able to set a rate within prescribed limits of the system 240.

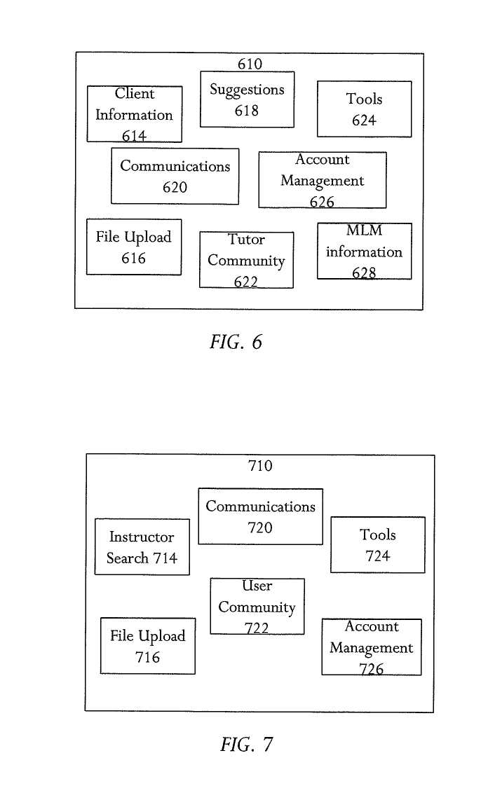

At step 495, the instructor may follow-up with the user, for example, using tools described below with reference to FIG. 6.

FIG. 5 illustrates an example process 500 that may be associated with mediation, according to an embodiment of the disclosure.

At step 510, the system 240 may initiate a recording of the instructional session. This may be done in a variety of manners and may depend on the particular types of media used in the session. For example, audio and/or video may be recorded along with an electronic recordation of anything visible on the screen by at least one of the participants. Additionally, any information shared between the participants may be recorded. The recording of the session according to particular configurations may serve multiple purposes, including providing a digital footprint showing that the session occurred, enabling quality control measures, and assisting in the mediation described below. Additionally, in particular embodiments, either or both of the user or instructor may be allowed to revisit any of the information in the recorded session. For example, the user may want to revisit the session to review notes in preparation for a test. Additionally, the instructor may want to revisit a session to understand what was covered in a previous session with a particular user in preparation for a follow-up session with the user.

In the review of these previous sessions, any of a variety of tools may be provided to instructors/users, including a fast forward, rewind and pause of audio and/or video in the session. Additionally, in particular embodiments, the audio for the session may be transcribed (automatically or via human-assisted transcription) for review and search by anyone reviewing the session. In particular embodiments, any of a variety of tools may be utilized to facilitate quick access to portions of the session, including word-indexes that jump to portions of the session where particular words were spoken.

At step 520, a determination may be made as to whether or not mediation should occur. This may be invoked in any suitable manner, including a request by a user or instructor or comments by the user or responses by the instructor. If mediation is determined to not occur, the process moves on to step 560. If mediation is to occur, the process 500 moves onto step 530.

At step 530, the mediation between a user and an instructor begins. A designated administrator or mediator may review the session that instigated the mediation session. The mediator may also review the profiles of the user and instructor along with past transactions for the instructor and user. Additionally, in particular configurations, the mediator may review previous recorded sessions of the user or previous recorded sessions of the instructor.

At step 540, after reviewing the information in step 530, the mediator may correspond with the user and the instructor. Among other things, the mediators may try to resolve the issues. Any of a variety of customer relationship incentives may be utilized (e.g., discounts on future sessions). The mediator may also see if the user is simply trying to abuse the system for discounted instructional sessions, for example, based on repeated historical transactions.

At step 550, a determination may be made as to whether the issue has been resolved or is not resolvable. If so, the process 500 may proceed on to step 560. If not, the process may continue with corresponding with the user and the instructor again at step 540 and/or reviewing more information at step 530. In particular configurations, unresolved issues may be elevated to another level of mediator designed to handle more complex issues.

At step 560, a determination may be made as to whether or not the recording should be deleted. The determination may based on factors such as, but not limited to, a passage of time, capacity in the system, and potential for issues arising for the instructor or user in the session. If not, the recording will be put back in the queue for consideration of whether or not to be deleted at another time. If so, the recorded session is deleted at step 570.

FIG. 6 illustrate several non-limiting examples of tools that may be provided to a instructor utilizing the system 240. These tools include a client information tool 614, a file upload tool 616, a suggestions tool 618, a communications tool 620, an instructor community tool 622, a media tool 624, an account management tool 626, and an MLM information tool 628.

The client information tool 614 may include information on the users that a particular instructor will be instructing. Additionally, within the client information tool 614, a instructor may be able to add notes about a particular session and/or a particular client. Further, if permitted by a user and the instructor, the notes that one particular instructor takes on a user may be shared with another instructor. Further, the client information tool 614 may include ticklers that remind a instructor to follow-up with a user.

The file upload tool 616 may allow the instructor to upload any of variety of tools the instructor wishes to upload. For example, in particular configurations, the instructor may be a teacher of a particular subject at a particular school that is providing an enhanced study sheet and study notes, and/or practice tests. In such embodiments, the instructor may charge a fee for access to such uploaded files. A user absent from a class on a particular day may be motivated to obtain such study notes from the teacher as opposed to a student that took notes on the particular day.

The suggestions tool 618 may provide any of a variety of tips or suggestions to a instructor on how to enhance the potential for more instructional sessions. For example, the system 240 may sense that a lot of users are searching for particular time slots for an instructor with particular qualifications. Thus, the system 240 may suggest to an instructor with the particular qualifications, but not the right time slot currently selected, that they may pick up some additional clients by adding such a time slot. The suggestion tool 618 may also suggest to an instructor what other instructors have successfully utilized in successful instructional sessions. The suggestion tool 618 may also provide trends in media tools that other have utilized.

The communications tool 620 may provide inbound and outbound communication capabilities for an instructor logged on to the system. For example, using this tool, an instructor may be able to provide responses to feedback. An instructor may also be able to communicate with other instructors and/or users without, for example, needing to separately access an email account.

The instructor community tool 622 may provide community features to the instructor to allow them to share ideas or experiences. Among the features in the community tool may be forums arranged according to any suitable criteria, for example, subject, geography, or textbook (e.g. in an educational setting). Other types of instructors may have other types of forums according to topics of interest to those types of instructors.

The tools tool 624 may provide a variety of tools that can be used by an instructor in a session. Such tools may be explored beforehand to allow an instructor to practice on using a tool for communication.

The account management tool 626 may allow an instructor to view a variety of information about his or her account. Examples include payments pending, payments received, bank deposit information, and profile.

The MLM information tool 628 may provide multi-level marketing (“MLM”) capabilities. In MLM, an instructor may receive a certain percentage of earnings of another instructor as a result of referring the other instructor to the system 240. The amount of earnings and the details of who the earnings are coming from may be viewed in the MLM information tool 628.

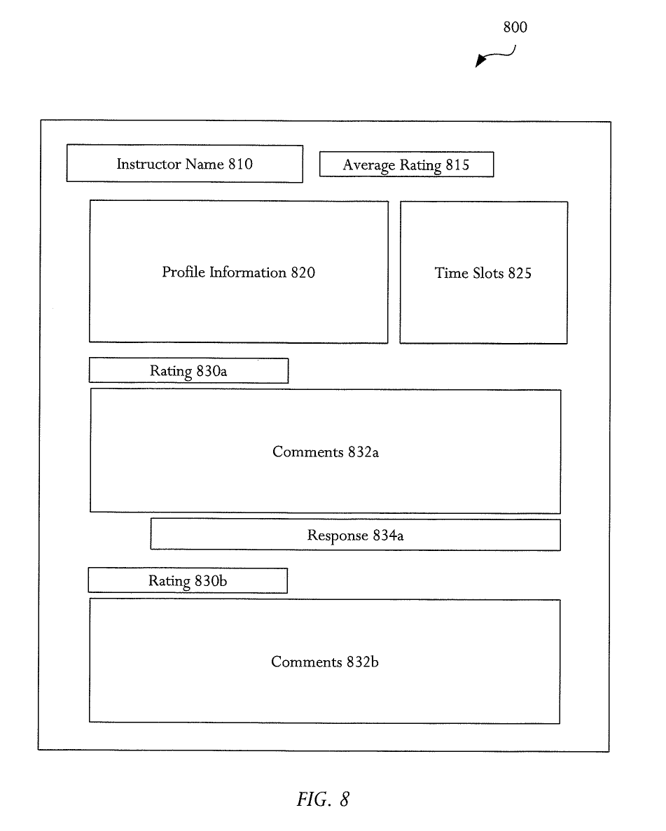

FIG. 7 illustrates several non-limiting examples of tools that may be provided to users of the system 240. These tools include an instructor search tool 714, a file upload tool 716, a communications tool 720, a user community tool 722, a media tool 724, and an account management tool 726. Some of these tools may be provided to users who are not logged into the system 240.

The instructor search tool 714 may generally include any features described above with reference to step 340 of FIG. 3.

The file upload tool 716 may allow a user to upload any of a variety of files to the system for either use in a instructor session or sharing with other users. For example, in particular configurations, a user may take a picture and send to an email associated with his or her account on the system. In other configurations, an application (“app”) on a mobile phone may allow one to upload a file or picture (e.g., taken on the mobile phone). In yet further configurations, other information such as a biological indicators (e.g., heartrate) and/or location may be sent to the instructor for feedback from the instructor.

The communications tool 720 may provide inbound and outbound communication capabilities for a user. For example, a user may comment on an instructional session or communicate with another user or instructor.

The user community tool 722 may correspond to a variety of tools that users may use to socially network with one another based on like interests. For example groups may be created on like profiles, like instructional sessions, or like instructors. In particular configurations, a user and/or and administrator may be able to create a group. Additional user forums may be created to allow users to post information and items.

As examples of potential uses for the user community, comments may be made, for example, on the quality of instructors or of professors in a college or university setting—regardless if the professor is currently registered with the system 240. Additionally, in particular configurations and subject to applicable regulation or laws, test files may be shared for particular classes.

The tools tool 724 may be similar to the media tools 624 of the instructor, allowing users to test drive tools before actually used in the session.

The account management tool 726 also may be similar to the account management tool of the instructor, except that payment information may be provided. Additionally, for a user profile, a user may choose who gets to see particular pieces of information. For example, instructors may only be able to see particular types of information whereas users may be able to see only other types of information.

FIG. 8 illustrates an example interface 800 of a profile of an instructor, according to an embodiment of the disclosure. The interface may include the instructor's name 810; an average rating of the instructor 815; instructional information 820; time slots 825; ratings 830a, 830b; comments 832a, 832b; and a response 834a.

The instructor's name 810 is simply a name for the instructor. The average rating of the instructor 815 may include the average rating for the instructor along with the number of individuals that have rated the instructor.

The instructor information 820 may include any relevant information for instruction. As an example, in an educational context, the instructor information 820 may include, among other information, the number of sessions for the instructor, the number of years the instructor has been teaching, the school the instructor teaches at, the textbooks the instructor teaches from, and any other relevant information. The instructor information 820 may also include a message from the instructor to potential users.

The time slots 825 may show what time the instructor is currently available as well as time slots that have currently been booked. In particular configurations, the time slots may be updated in real-time. For example, one viewing the profile may see the time slots 825 change as a particular slot has been modified. Such a feature avoids one attempting to book a time to only find out that the time has already been booked.

The ratings 830a, 830b may respectively correspond to a rating provided by two users who have had a session with the instructor. Any suitable rating methodology may be used, for example, stars, numbering, or the like. In particular configurations, only users who have actually taken a session may be allowed to rate or comment on an instructor. In addition to the rating provided by a user, the user providing the rating may also be identified. In such configurations, one looking at the interface 800 may simply click on a link for the user providing the rating to communicate with the user providing the rating, for example, using the communication tool 720 of FIG. 7.

A response 834a from the instructor may also be provided under certain comments, depending on which comments (if any) the instructor chooses to respond to.

Although particular user interfaces and comments/rating features have been shown and described above, others may be utilized in other configurations as will become apparent to one of ordinary skill in the art, having read the specifications

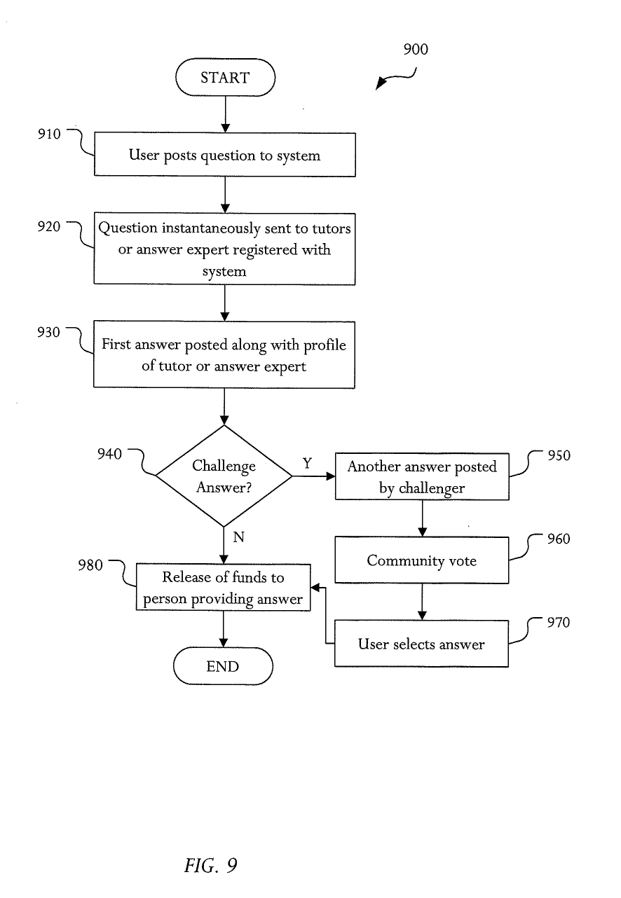

FIG. 9 shows another process 900 for submitting questions to the “cloud”, according to an embodiment of the disclosure. In particular scenarios, a user may not want to engage in a instructional session. They may simply have a question that they want an answer to—fast. Accordingly, the process 900 provides the ability of user to submit a question to the “cloud,” which may correspond to the communication system 100 of FIG. 1, and receive relatively quick answers.

In step 910, a user posts a question along with appropriate payment authorization. In particular configurations, an answer for a question may have a flat rate.

In step 920, after the question is posted, the question is instantaneously communicated to answerers registered with the system 240. The system in this particular configuration need not necessarily be limited to only instructors, but may also include others wishing to provide answers in return for compensation. In particular configurations, only certain types of questions may be routed to particular answerers, for example, according to a profile of the answerer and the nature of the question.

At step 930, the first person to answer the question gets their answer posted to the system. In addition to the answer, the profile of the person answering the question may be provided along with relevant answering statistics, for example, the number of answers provided and the number of answers challenged (described below). This answer may also instantaneously be communicated to the same group that the question was circulated.

At step 940, after an answer has been posted, there may be an opportunity to challenge the answer according to particular configurations. If a challenge or challenges to the answer are asserted, an answer may be posted by a challenger at step 950. Similar to other answers, this answer may instantaneously be communicated to the group indicated above. After such postings, the community may be given the opportunity to vote on answers at step 960. Ultimately, the user looking at the answers and the voting may select the answer at 970.

If there is no challenge to the answer after a given time period, the funds may be released at step 980 to the person providing the answer. Additionally, for challenged answers, the person providing the answer selected by the user receives the compensation provided by the user.

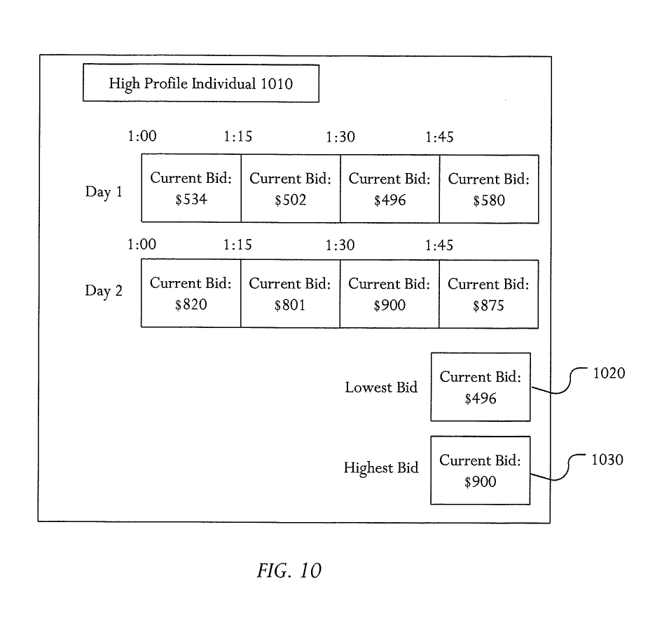

FIG. 10 illustrates another embodiment of the disclosure for scheduling time of a “high profile” individual, according to an embodiment of the disclosure. In this embodiment, an individual (not necessarily an instructor) may allow others access to a block of his or her time using the communication systems described herein. Such individuals may be “high profile” individuals including, but not limited to, experts, celebrities, successful business individuals, authors, scholars, and the like. Such embodiments are similar to the embodiments described herein; however, instead of being instructed, one may be simply interacting with an individual.

It is extremely difficult for the average Joe to get access to high profiles individuals. Among other contributing factors, security, hectic schedules, and geographical locations prohibit one from interacting with a high profile individual. Using the communication system and booking systems described herein, one may be able to book the time of an individual such as a favorite celebrity, favorite singer, or sports hero. All each needs is an endpoint (e.g., computer) capable of communicating with the other endpoint (e.g., another computer) over a network (e.g., the Internet). As a simple example, in particular embodiments, each endpoint may be a computer equipped with a webcam communicating with one another through video Skype.

A high profile individual may set his or her own fee or, alternatively, the high profile individual may allow the community to bid for time slots. FIG. 10 shows a simplified example of an interface for a bidding process of a high profile individual 1010. There are four time slots on days 1 and 2, each having fifteen minutes in time. The current bid for each is showing in the respective block. Any suitable interface may be used to increase the bid amount. Examples include clicking on the box and being prompted for a new bid amount (e.g., after providing appropriate payment information).

Other interfaces may allow one to bid for current lowest time slot as indicated by box 1020. For example, the box with a bid of $496 is the current lowest in FIG. 10; however, a later box may later be the lowest. Likewise, one may bid on the current highest box as indicated by box 1030.

In particular embodiments, the bidding may be done with other than monetary value. For example, a company may reward points for using products and the points may be used to bid. Alternatively, points may be given for volunteering with an organization and such volunteer points may be used to bid. A variety of other reward schemes may also be utilized. Although a single high profile individual is shown, others may be listed on the system 240. And, for each listing, there may be an indication of information listed for each particular high profile individual name, including, but not necessarily limited to, (i) timeslots available, (ii) highest amount, (iii) lowest amount, (iv) average amount, and (vi) time to end of bidding for each individual.

As alluded to above, in certain embodiments, the virtual instructional session may correspond to a working professional sharing time and experiences with a user. Such embodiments may be viewed as a virtual apprenticeship or virtual mentorship where a user will gain knowledge of how actual working professionals interact in their jobs in the real world. Such virtual apprenticeship/mentor sessions may allow users to gain real world experience without physically being present with the working professional. As an example of the above, a working professional may be traveling; however, they may have a session where they share certain experiences with users. Such shared experience may, for example, include select scenarios from preceding days or a preceding week.

In certain scenarios, the working professional may provide assignments to the users with deadlines for the assignments. Additionally, in particular configurations, the virtual apprenticeship/mentoring sessions may count for college credit for certain degrees or serve as a resume builder, for example, when the working professional is known by others. Because of the potential high demand for time of certain working professionals, multiple users may apply for acceptance as the mentee of certain working professionals. In such configurations, the system may facilitate the application process and allow the working professional to accept which applicants will be accepted.

According to the various embodiments described above, one need only network access to provide and/or receive instruction on a limitless number of items. Although various embodiments have been described in the singular, in certain embodiments, more than one may engage in a session with an instructor.

According to particular embodiments, federal grants and/or scholarships may provide a source of funding for individuals unable to pay for instructors.

According to various embodiments described herein, a wealth of information may be gathered on users, whether it is publically capable of being disclosed or not. In particular configurations, to the extent allowable by law, this information may be gathered in the aggregate for marketing and data mining purposes. For example, a group of users may be identified as being potential candidates for a new type of study aid.

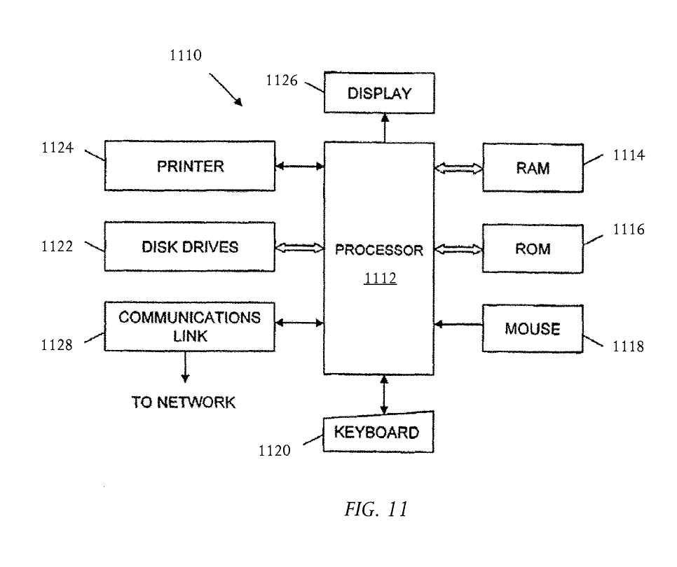

FIG. 11 is an embodiment of a general purpose computer 1110 that may be used in connection with other embodiments of the disclosure to carry out any of the above-referenced functions and/or serve as a computing device for endpoint(s) 110 and endpoint(s) 120 of FIG. 1. General purpose computer 1110 may generally be adapted to execute any of the known OS2, UNIX, Mac-OS, Linux, Android and/or Windows Operating Systems or other operating systems. The general purpose computer 1110 in this embodiment includes a processor 112, a random access memory (RAM) 1114, a read only memory (ROM) 1116, a mouse 1118, a keyboard 1120 and input/output devices such as a printer 1124, disk drives 1122, a display 1126 and a communications link 1128. In other embodiments, the general purpose computer 1110 may include more, less, or other component parts. Embodiments of the present disclosure may include programs that may be stored in the RAM 1114, the ROM 1116 or the disk drives 1122 and may be executed by the processor 1112 in order to carry out functions described herein. The communications link 1128 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 1122 may include a variety of types of storage media such as, for example, floppy disk drives, hard disk drives, CD ROM drives, DVD ROM drives, magnetic tape drives or other suitable storage media. Although this embodiment employs a plurality of disk drives 1122, a single disk drive 1122 may be used without departing from the scope of the disclosure.

Although FIG. 11 provides one embodiment of a computer that may be utilized with other embodiments of the disclosure, such other embodiments may additionally utilize computers other than general purpose computers as well as general purpose computers without conventional operating systems. Additionally, embodiments of the disclosure may also employ multiple general purpose computers 1110 or other computers networked together in a computer network. Most commonly, multiple general purpose computers 1110 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 11, the logic includes computer software executable on the general purpose computer 1110. The medium may include the RAM 1114, the ROM 1116, the disk drives 1122, or other mediums. In other embodiments, the logic may be contained within hardware configuration or a combination of software and hardware configurations.

The logic may also be embedded within any other suitable medium without departing from the scope of the disclosure.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for a remote instructional session, the system comprising:
one or more servers (240) configured to:
receive, from an endpoint (220) corresponding to an instructor, information associated with a schedule for which users may book time for an instructional session with the instructor (440);
receive, from an endpoint (210) corresponding to a user, search parameters for instructors (340);
provide, to the endpoint corresponding to the user, search results corresponding to the search parameters for the instructors;
receive, from the endpoint corresponding to the user, booking information for a particular time with the instructor (350); and
initiate a remote instructional session over a network at the particular time, the remote instructional session including the sharing of digital information between the endpoints associated with the user and the instructor (370, 460).

2. The system of claim 1, wherein digital information is audio and video shared between the user and the instructor.

3. The system of claim 1, wherein digital information is a virtual blackboard simultaneously displayed on displays associated with the endpoints of the instructor and the user.

4. The system of claim 3, wherein the one or more servers are further configured to:
receive updates to the virtual blackboard from one or both of endpoints associated with the instructor and the user.

5. The system of claim 3, wherein the one or more servers are further configured to:
receive, from the user, comments on the instructional session.

6. The system of claim 5 wherein the one or more servers are further configured to: receive, from the instructor, a response to the comments on the instructional session (480).

7. The system of claim 1, wherein the one or more servers are further configured to: record the instructional session (510).

8. The system of claim 1, wherein the one or more servers are further configured to: provide access to the user of the recorded session.

9. The system of claim 1, wherein the remote instructional session is between the instructor and the plurality of users.
